(19) United States
(12) Patent Application Publication
(10) Pub. No.: US 2023/0076904 A1
(43) Pub. Date: Mar. 9, 2023

(54) ACCESSORY DOOR HANDLE

(71) Applicant: GCI, Inc., San Francisco, CA (US)

(72) Inventors: David Arthur Cooper, Concord, CA (US); Jesse James Swafford, Vacaville, CA (US); Jonathan Robert Helman, Tiburon, CA (US)

(73) Assignee: GCI, Inc., San Francisco, CA (US)

(21) Appl. No.: 17/467,940

(22) Filed: Sep. 7, 2021

(51) Int. Cl. E05B 1/00

(52) U.S. Cl. CPC E05B 1/0053; E05B 1/003; E05B 1/0084

(57) ABSTRACT

An accessory door handle can be clamped onto an existing door handle currently installed in the door. The accessory door handle can be dedicated for use when an individual is wearing gloves, so that the existing door handle may be reserved for use when not wearing a glove. This decreases the chances of contamination and makes the handles easier to clean. The accessory door handle is suitable for use in laboratory and clean room conditions.

### BACKGROUND

This application generally relates to door opening and closing mechanisms used in clinical and research laboratories, hospitals, doctor's offices, biotechnology facilities, and other areas where governmental and/or industry regulations require that personnel wear gloves and that door opening and closing mechanisms not come in contact with the gloves worn by personnel working in said area. Other environments where the present invention may be beneficially implemented include manufacturing or those related to food preparation or meal service, such as restaurants, commercial kitchens, industrial food processing facilities, and the like.

In workplaces where personnel are likely to come into contact with hazardous substances, personal protective equipment, or PPE, is required to protect employees from serious workplace injuries or illnesses resulting from contact with chemical, radiological, physical, electrical, mechanical, or other workplace hazards.

PPE includes a variety of devices and garments such as face shields, safety glasses, hard hats, safety shoes, goggles, coveralls, gloves, vests, earplugs, and respirators.

In particular with regard to gloves, Occupational Safety and Health Standards (“OSHA”) § 1910.138(a) states the general requirement that employers shall select and require employees to use appropriate hand protection when employees' hands are exposed to hazards such as those from skin absorption of harmful substances; severe cuts or lacerations; severe abrasions; punctures; chemical burns; thermal burns; and harmful temperature extremes.

The present invention is directed to those environments where gloves are a required form of PPE, and to solving the problems related to glove use.

Workplaces where gloves are used to protect personnel from hazardous chemicals and infectious materials commonly have protocols in place to prevent contamination of the various surfaces, including door handles, that are present in those environments. Preventing contamination is particularly important in workplaces where gloved and ungloved employees are sharing the same work area, such as research laboratories and biotechnologies facilities, where researchers are often working alongside office personnel or other staff that are not wearing gloves.

In these environments, personnel wearing gloves must often refrain from touching door handles, elevator buttons, telephones, lavatory faucets, or other common surfaces, and are required to remove gloves before touching personal items, such as phones, computers, pens and their skin. Disposable gloves must be discarded once removed, and cannot be saved for future use because, once used, gloves are considered contaminated. Gloves must also be removed upon exiting the laboratory or entering into a common area to prevent cross-contamination of commonly used surfaces. To the extent that the facility in question uses non-disposable or reusable gloves, those gloves must be washed and dried, as needed, and then inspected for tears and holes prior to reuse.

In the types of hazardous environments described above, conventional door handles are problematic for gloved personnel. Every time a gloved employee needs to open or close a door, they are required to remove at least one glove to make contact with the door handle. The results in a waste of both time, because the employee may be required to wash the hand from which the glove was removed before contacting the door handle, and resources in the form of single-use gloves that must be disposed of after one use.

Many of the existing facilities where gloves are required (e.g., clinical or research laboratories, clean rooms, and biotechnology environments) were built using conventional door handles, such as a knob style handle comprising a round circular, semicircular, or oval knob which the user turns to release the catch and open the door or a lever style handle comprising a short level arm which the user lifts or depresses to release the catch and open the door. Regardless of type, these conventional door handles usually only have one means of opening or closing the door, such that every person wishing to open the door is required to contact the same main opening mechanism, e.g., the knob, lever, or handle.

Therefore, a need exists for an apparatus that allows laboratory personnel to move within the laboratory, and from laboratory to laboratory, potentially through common areas or non-laboratory areas, without having to remove their gloves and engage in any other required safety measures collateral to glove removal, such as washing hands.

Further, there exists a need to provide the apparatus described above without the costs, in terms both parts and labor, associated with removing and replacing existing door opening mechanisms, which in large facilities could represent hundreds or thousands of door handles and result in substantial, and perhaps cost prohibitive, expenses.

### SUMMARY OF INVENTION

To overcome the problems described above, and to overcome other limitations that will become apparent upon reading and understanding the present specification, the present invention discloses a novel accessory handle.

The disclosed accessory handle may be attached to an existing door handle to provide a second handle for opening and closing the door. The accessory handle disclosed herein may be particularly useful for use in laboratories, clean rooms, and other environments in which contamination needs to be controlled and where individuals may be required to wear gloves. As described above, conventional door opening mechanisms require personnel to remove gloves each time they need to open a door, or to ask for someone else to open the door for them. The disclosed accessory handle allows individuals wearing PPE to operate doors without needing to take off gloves or seek assistance from another person.

An object of some embodiments of the present invention is to provide a door opening solution that does not require the expensive removal and replacement of existing door handles. A further object of some embodiments is to provide a solution where both gloved and ungloved personnel have the ability to use the same door opening mechanism. A further object of some embodiments is to provide a door opening solution that can fit over and accommodate the existing mechanical features of various types of door handles, including without limitation knob style handles as well as lever style handles. A further object of some embodiments is to provide an accessory door handle in which the existing door handle can be easily removed to install the accessory door handle. A further object of some embodiments is to provide a universal modular door accessory that can be used with existing door handles present on either side of the door, and for use by both right-handed and left-handed persons.

### BRIEF DESCRIPTION OF THE DRAWINGS

The various embodiments of the invention are described in more detail with reference to the advantageous embodiments presented as examples and to the accompanying drawings, in which:

FIG. 1 depicts a perspective view of an accessory handle according to an embodiment.

FIG. 2 depicts a perspective view of an accessory handle according to an embodiment.

FIG. 3 depicts a front view of an accessory handle according to an embodiment.

FIG. 4 depicts a close-up view of the clamp portion of an accessory handle according to an embodiment.

FIG. 5 depicts an embodiment in which the clamp portion of the accessory handle comprise a top plate and a separate bottom plate.

FIG. 6 depicts an embodiment in which a shape adapter is used to define a shape of the slot of the clamp portion of the accessory handle to better conform to the shape of the existing door handle.

FIG. 7 depicts a close-up view of the underside of the clamp portion of an accessory handle according to an embodiment.

FIG. 8 depicts a side view of the opening side of the clamp portion according to an embodiment.

FIG. 9 depicts a close-up view of the underside of the handle portion including a recessed portion shaped to form contact points. The shape of the recessed portion and the corresponding shape of the upper side of the clamp portion allows for alternate placements of the handle portion according to the door swing and existing handle placement.

FIG. 10 depicts a close-up view of the upper side of the clamp portion including a raised portion shaped to form contact points. The shape of the raised portion and the corresponding shape of the recessed portion on the underside of the handle portion allows for alternate placements of the handle portion according to the door swing and existing handle placement.

### DETAILED DESCRIPTION

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

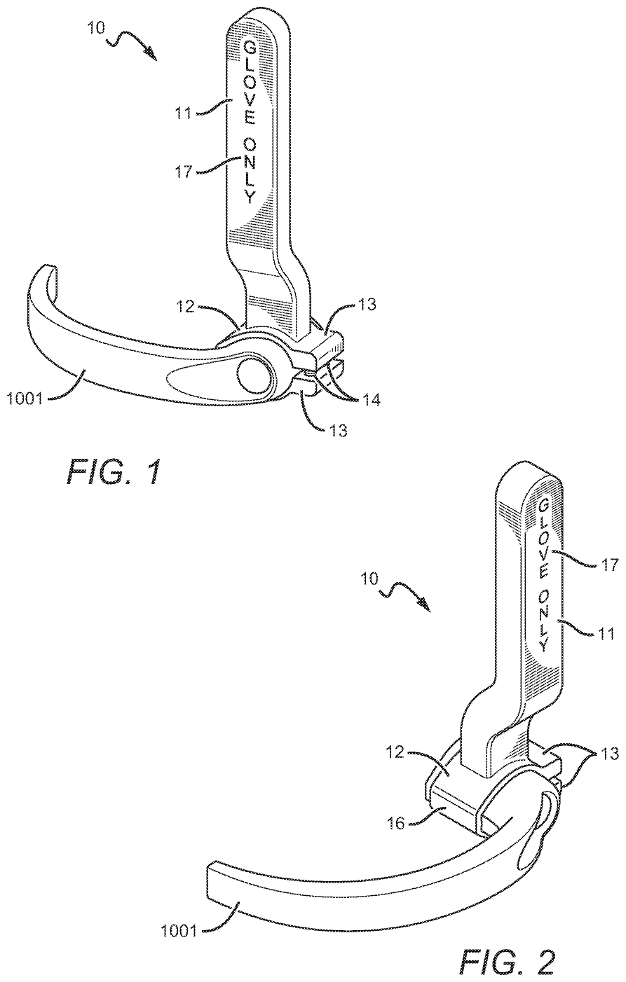

FIGS. 1-3 depict an accessory handle 10 according to an embodiment. The handle comprises a bar portion 11 and a clamp portion 12.

As seen in FIG. 1, the accessory handle 10 may be attached to an existing door handle currently installed into the door via the clamp portion 12. An individual may use the accessory handle 10 to turn the door handle 1001 without touching any part of existing door handle 1001.

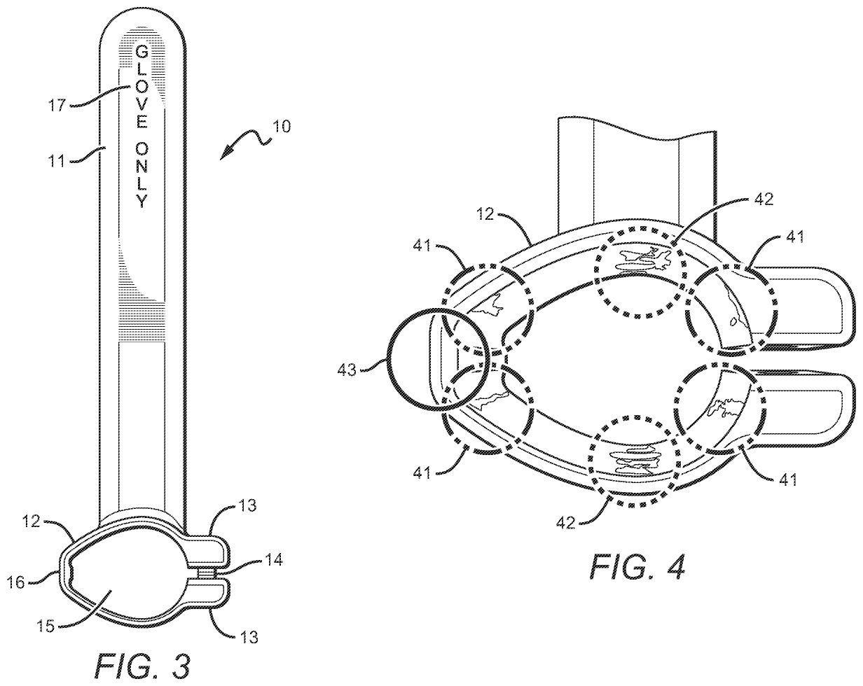

The clamp defines a slot 15 through which the door handle 1001 fits. As shown in FIG. 3, the shape of the slot 15 can be tailored to exactly match the shape of a particular door handle. Alternatively, slot 15 may be made into a shape designed to fit a large number of different door handles, such as either a knob style or lever style, and regardless of whether the shape of the attachment point on door handle 1001 is circular or oval. In other embodiments, the edges of the slot may optionally be lined with rubber or other high friction material (not shown) to improve fit and the strength of the grip between the clamp portion 12 and the door handle 1001. The clamp portion 12 includes two lips 13. The handle 10 can be made to fit more snugly and securely over the door handle 1001 by tightening the attachment screws 14 to bring the lips 13 closer together. In one embodiment the clamp portion 12 is secured to the door handle 1001 with attachment screws. In some embodiments, the attachment screws can be those known in the art, for example M5×10 screws. In another embodiment, the attachment screws can be screws with custom thread thickness and thread pitch to ensure a more secure installation.

The accessory handle 10 as shown in FIGS. 1-3 is installed by first removing door handle 1001, attaching accessory handle to the door handle 1001, and then replacing the completed assembly of door handle 1001 and accessory handle 10 onto the door. This results in the handle 10 being attached to the door handle 1001 such that the accessory handle can be left installed permanently, or can be removed if necessary in the event the existing door and/or handle are replaced, allowing the accessory handle to be reused on the replacement door.

FIG. 4 depicts a close-up view of the clamp 12. The four areas 41 bear the rotational load when a user is turning the handle 10 to open the door and prevent the handle 10 from rotating around the shaft of the existing door handle without also moving the said existing door handle. The two areas 42 bear the pushing and pulling load when someone opens or closes the door using the handle 10 and prevent handle 10 from tilting backward or forward when opening the door. Area 43 bears a sideways load during the clamping process.

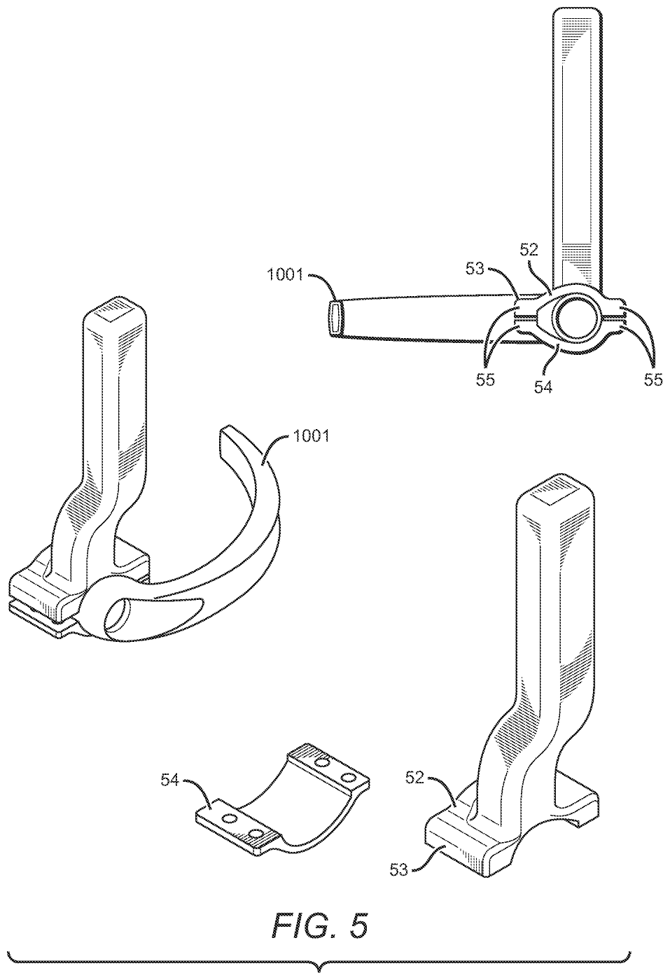

FIG. 5 depicts an embodiment in which the clamp portion 52 of the accessory handle comprise a top plate 53 that is apiece with the handle and a separate bottom plate 54. This design allows the handle to be installed on a door handle that is already attached to the door. The bottom plate 54 is attached to the top plate 53 using attachment screws through the lips 55.

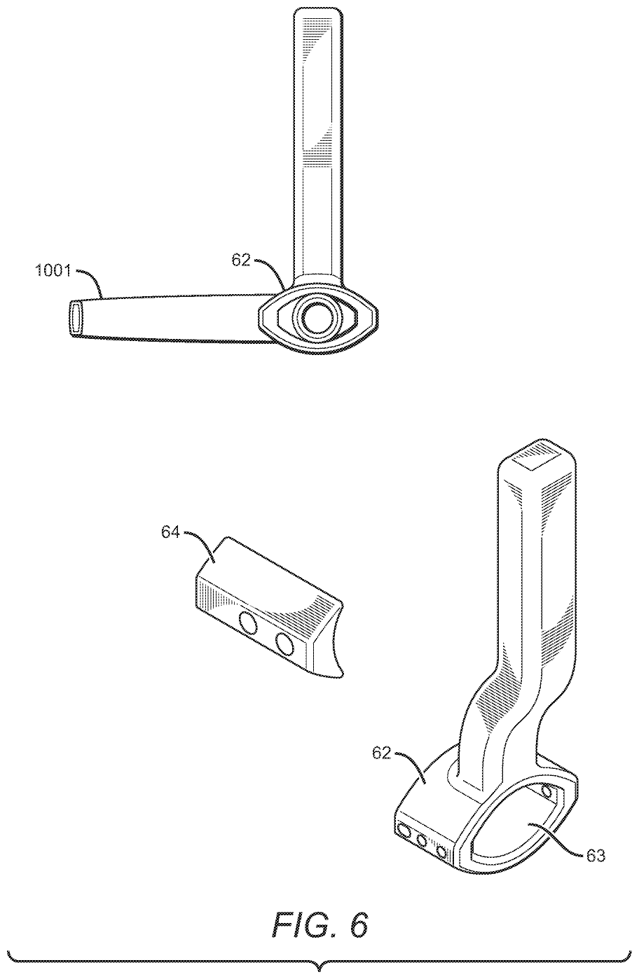

FIG. 6 depicts an embodiment in which the clamp portion 62 of the accessory handle is a single piece and defines a slot 63 through which a door handle can fit. To accommodate different shapes of the door handle, an adapter 64 designed to fit into the slot 63 may be used to better conform to the shape of the door handle.

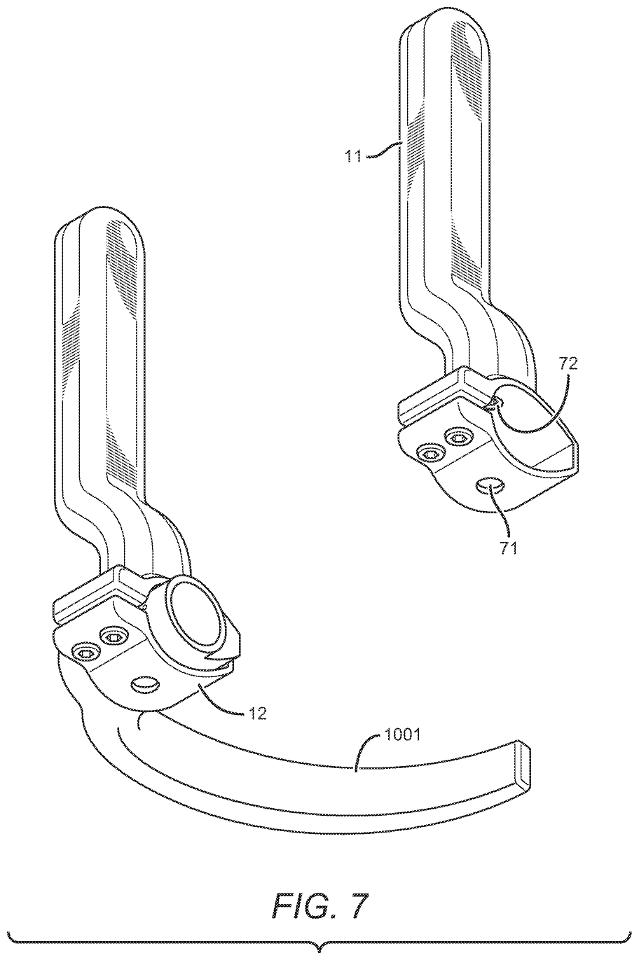

FIG. 7 depicts a view of the underside of clamp portion 12 of the accessory handle showing an access hole 71 in the bottom of the clamp portion 52 to allow a screwdriver or other tool access to the handle attachment screw 72. In one embodiment the bar portion 11 is secured to the claim portion 12 with a standard attachment screw known in the art, for example a M4×25 screw. In other embodiments, the attachment screws can be screws with custom thread thickness and thread pitch to ensure a more secure installation. The attachment screw 72 is located on the underside of bar portion 11 such that the attachment screw 72 will not be visible once the handle 10 is installed.

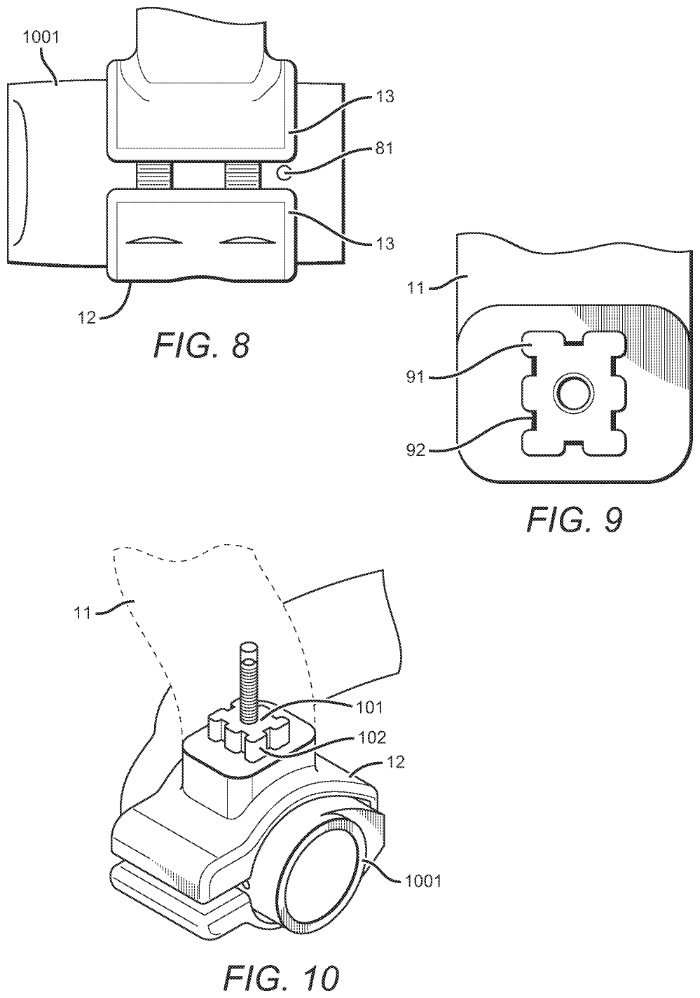

FIG. 8 depicts a side view of clamp portion 12 of the accessory handle in which the lips 13 of the claim portion 12 are spaced sufficiently apart to allow access to the pin mechanism 81 of the door handle 1001.

FIGS. 9 and 10 depict a close up of the manner in which handle portion 11 attaches to clamp portion 12. The surface of the bottom of handle portion 11 has a recessed portion 91 of generally rectangular shape, with six molded upper contact points 92 distributed around the edge of recessed portion 91 as shown in FIG. 9. Clamp portion 12 has on its top surface a raised portion 101 that matches the shape of the recessed portion 91 in the bottom of handle portion 11, and similarly has six lower contact points 102 distributed around the edge of raised portion 101. When assembled, the raised portion 101 on the top surface of clamp portion 12 slides into the recessed portion 91 on the bottom surface of handle portion 11, aligning the upper contact points 92 with the lower contact points 102. The shape of recessed portion 91 and raised portion 101, as well as the alignment of the upper contact points 92 with the lower contact points 102 provides the benefit of an extremely strong connection between handle portion 11 and clamp portion 12, preventing any twisting or shearing between said parts.

The shape of the raised portion 101 on clamp portion 12 and the corresponding shape of the recessed portion 91 on the underside of the handle portion 11 allows for alternate placements of the handle portion 11 according to the door swing and existing door handle placement. The shape combined with the use of a single attachment screw 72 allows for rotating the placement of the handle portion 11 to allow for both left- and right-hand doors, creating a universal door handle accessory able to be installed on almost any existing door and handle.

The accessory handle may be made from aluminum or another material that is easy to clean and sterilize. An eye-catching finish may be applied to the handle to make it more likely to be noticed by people. For instance, if made of aluminum, the handle may be anodized to a red color. Other material and other colors may be used as appropriate based on the specifics of the environment. With reference to FIGS. 1-3, the handle may also include a conspicuous legend 17, which may be inlaid or use embossed or embedded lettering, to remind personnel of proper usage of the handle.

The foregoing description of the embodiments of the invention have been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An accessory door handle, comprising:
a handle portion substantially in the form of a vertical bar for opening or closing a door; and
a clamp portion for attaching the accessory door handle to an existing door handle;
wherein the clamp portion defines a slot closely fitting the existing door handle; and
wherein the clamp portion comprises a top lip portion and a bottom lip portion that may be tightened to allow the clamp portion to grip the existing door handle.

2. The accessory door handle according to claim 1, wherein
the handle portion and the clamp portion are separable.

3. The accessory door handle according to claim 2, wherein
the handle portion comprises a recessed portion on the bottom surface; and
the clamp portion has a raised portion on the upper surface;
wherein the raised portion of the claim portion fits into the recessed portion of the handle portion.

4. The accessory door handle according to claim 3, wherein
the recessed portion on the bottom surface of the handle portion is shaped to have a plurality of first contact points distributed around the edge of the recessed portion.

5. The accessory door handle according to claim 4, wherein
the raised portion on the upper surface of the clamp portion is shaped to have a plurality of second contact points distributed around the edge of the recessed portion; and,
wherein the plurality of first contact points on the recessed portion on the bottom surface of the handle portion aligns with the second plurality of contact points on the raised portion.

6. The accessory door handle according to claim 2, wherein
the handle portion is attached to the clamp portion via a single attachment screw.

7. The accessory door handle according to claim 6, wherein
the clamp portion has an access hole in its bottom surface to allow a tool to pass through and reach the attachment screw.

8. The accessory door handle according to claim 2, wherein
the lip portions of the clamp portion may be tightened by a plurality of tightening screws that thread through both the top lip portion and bottom lip portion.

9. The accessory door handle according to claim 8, wherein
the clamp portion is operable to be tightened around the existing door handle to prevent slipping of the clamp portion around the existing door handle when the door is opened or closed.

10. The accessory door handle according to claim 9, wherein
the clamp portion comprises an inner surface that makes contact with the existing door handle, wherein said inner surface is shaped such that at least four sections of the inner surface bear the rotational load when the accessory handle is used to open or close the door.

11. The accessory door handle according to claim 10, wherein
the clamp portion comprises an inner surface that makes contact with the existing door handle, wherein said inner surface is shaped such that at least two sections of the inner surface bear the pushing or pulling load when the accessory handle is used to open or close the door, such that the door handle accessory does not tilt during the opening or closing.

12. An accessory door handle, comprising:
a handle portion operable to open or close the door; and
a clamp portion for attaching the accessory door handle to an existing door handle;
wherein the clamp portion attaches around the existing door handle.

13. The accessory door handle according to claim 12, wherein
the handle portion and the clamp portion are separable.

14. The accessory door handle according to claim 13, wherein
the handle portion comprises a recessed portion on the bottom surface; and
the clamp portion has a raised portion on the upper surface;
wherein the raised portion of the claim portion fits into the recessed portion of the handle portion.

15. The accessory door handle according to claim 14, wherein
the recessed portion on the bottom surface of the handle portion is shaped to have a plurality of first contact points distributed around the edge of the recessed portion.

16. The accessory door handle according to claim 15, wherein
the raised portion on the upper surface of the clamp portion is shaped to have a plurality of second contact points distributed around the edge of the recessed portion; and,
wherein the plurality of first contact points on the recessed portion on the bottom surface of the handle portion aligns with the second plurality of contact points on the raised portion.

17. The accessory door handle according to claim 12, wherein
the handle portion is attached to the clamp portion via a single attachment screw.

18. The accessory door handle according to claim 17, wherein
the clamp portion has an access hole in its bottom surface to allow a tool to pass through and reach the attachment screw.

19. The accessory door handle according to claim 12, wherein
the clamp portion comprises a top lip portion and a bottom lip portion that may be tightened to allow the clamp portion to grip the existing door handle; and
wherein the clamp portion may be tightened by a plurality of tightening screws that thread through both the top lip portion and bottom lip portion.

20. The accessory door handle according to claim 19, wherein
the clamp portion is operable to be tightened around the existing door handle to prevent slipping of the clamp portion around the existing door handle when the door is opened or closed.

21. The accessory door handle according to claim 12, wherein
the clamp portion comprises an inner surface that makes contact with the existing door handle, wherein said inner surface is shaped such that at least four sections of the inner surface bear the rotational load when the accessory handle is used to open or close the door.

22. The accessory door handle according to claim 21, wherein
the clamp portion comprises an inner surface that makes contact with the existing door handle, wherein said inner surface is shaped such that at least two sections of the inner surface bear the pushing or pulling load when the accessory handle is used to open or close the door, such that the door handle accessory does not tilt during the opening or closing.

23. An accessory door handle, comprising:
a handle means operable to open or close the door; and
a clamp means for attaching the accessory door handle to an existing door handle;
wherein the bottom of the handle means attaches to the top of the clamp means.

24. The accessory door handle according to claim 23, wherein the clamp means further comprises grip means for bearing a load force when the door is operated.

25. The accessory door handle according to claim 23, further comprising:
a shape adapter means for conforming the accessory door handle to the shape of the existing door handle.
